(19) United States
(12) Patent Application Publication
(10) Pub. No.: US 2026/0275797 A1
(43) Pub. Date: Sep. 17, 2026

(54) Method for opening a trunk lid of a motor vehicle

(71) Applicant: AUDI AG, Ingolstadt (DE)

(72) Inventor: Paul STAS, Stammham (DE)

(73) Assignee: AUDI AG, Ingolstadt (DE)

(21) Appl. No.: 19/562,392

(22) Filed: Mar. 10, 2026

(30) Foreign Application Priority Data
Mar. 11, 2025 (DE) 10 2025 109 217.6

(51) Int. Cl. E05F 15/75

(52) U.S. Cl. CPC E05F 15/75; E05Y 2400/822; E05Y 2900/548

(57) ABSTRACT

A method of opening a trunk lid of a motor vehicle may include detecting a touch of a user by a detection device arranged on or in an emblem of the trunk lid. Furthermore, the trunk lid is unlocked and the emblem is illuminated depending on the detected touch, such that the trunk lid is opened in an automated manner.

### CROSS-REFERENCE TO RELATED APPLICATIONS

This application claims the priority benefit of German Patent Application No. 10 2025 109 217.6 filed on Mar. 11, 2025, which is incorporated by reference herein in its entirety.

### BACKGROUND

### FIELD

An invention according to described examples relates to a method for opening a trunk lid of a motor vehicle, a system, a computer program, a computer-readable storage medium, and a motor vehicle.

### DESCRIPTION OF RELATED ART

Rear hatches of motor vehicles often have automated and convenient opening options for a user. Electronic opening systems typically use an electric motor that is activated via a switch, a remote control, or a foot sensor system. In modern vehicles, systems that enable contactless control are often used, for example, by a foot movement under the rear bumper, due to which the rear hatch automatically opens. These systems are based on the detection of motion or special sensors that identify the driver or another authorized person.

However, there is often no feedback of the motor vehicle to the user that an operation of a switch which characterizes the opening of the rear hatch will take place. This only becomes apparent to users when the rear hatch is unlocked or even moved.

### SUMMARY

The present invention according to the examples is based on an example object of improving the opening of a trunk lid of a motor vehicle.

The example object may be achieved by the subjects of the independent claims. Advantageous refinements of the invention according to the examples are described by the dependent claims, the following description, and the figure(s).

A first aspect relates to a method for opening a trunk lid of a motor vehicle. In a first step, a touch of a user is detected by a detection device, wherein the detection device is arranged on or in an emblem of the trunk lid. Furthermore, the trunk lid is unlocked depending on the detected touch, the emblem is at least partially illuminated depending on the detected touch, and the trunk lid is opened in a partially automated manner.

The invention according to the examples is based on the concept that the user receives a confirmation via visual feedback that the command of the user to open the trunk lid or rear hatch of the motor vehicle has been detected and will be implemented. The command is detected by touching, in particular pressing, the emblem in this case, wherein the emblem identifies the type of the motor vehicle. For example, a user of the motor vehicle can recognize which producer has produced the motor vehicle from the emblem. For this purpose, the motor vehicle usually has the emblem in the area of the trunk lid. According to the examples of the invention, the already existing arrangement of the emblem can be expanded accordingly. On the one hand, a user input can be detected using the emblem or a detection device arranged on or in the emblem. Furthermore, illumination of the emblem can provide an efficient option for providing feedback to the user that their user input has been detected and recognized.

A second aspect relates to a system configured to carry out the method according to the first aspect.

A third aspect relates to a computer program which, when the program is executed by a computer, causes the computer to carry out the method according to the first aspect.

A fourth aspect relates to a computer-readable storage medium comprising commands which, when they are executed by a computer, cause the computer to carry out the method according to the first aspect.

A fifth aspect relates to a motor vehicle configured to carry out the method according to the first aspect, a system according to the second aspect, a computer program according to the third aspect, or a computer-readable storage medium according to the fourth aspect.

According to an example, the emblem identifies a producer of the motor vehicle. In an example, the emblem uniquely identifies a producer of the motor vehicle. Emblems of motor vehicles are essentially used to identify the motor vehicle, so that it is clearly recognizable to third parties which company has produced the motor vehicle. Since emblems are regularly provided for this purpose in the rear area of motor vehicles, only minor adaptations may be necessary to be able to implement the method according to the first aspect or a system according to the second aspect. In particular, it may be intuitive for a user of the motor vehicle to use the emblem of the motor vehicle to open a trunk lid of the motor vehicle. This effect can be amplified by the illumination of the emblem, so that the feedback can be communicated particularly effectively to the user that the desired implementation, namely opening the trunk lid, is implemented.

According to a further example, the emblem faces toward the user in an operating position, in which the trunk lid is locked and a touch of the user is detectable. This can enable a user to operate the emblem particularly easily and be able to open the trunk lid. Because the emblem faces toward the user, the user can touch the detection device or the emblem in general particularly conveniently with a body part such as a finger. In an example, bending the wrist or the elbow is essentially unnecessary, since the emblem is arranged at the height of the body part of the user when the user is standing. Particularly ergonomically gentle opening of the trunk lid can thus be achieved.

According to another example, the emblem is essentially completely visible to the user in an operating position in which the trunk lid is locked if the user is located in the surroundings of the motor vehicle in which the emblem can be touched with at least one body part of the user. In this way, the user can receive visual feedback that their touch has been detected by the detection device with increased probability upon operation of the detection device, in that the emblem illuminates.

According to another example, the position of the emblem in relation to the motor vehicle is changeable by touching the user. In this context, the emblem can be configured such that the emblem can be changed with respect to its rest position, when it is arranged on or in the trunk lid, by a touch of the user. For example, the emblem can be pivotable or tiltable, rotatable, or can be at least partially depressed into the trunk lid. The user of the motor vehicle therefore receives additional haptic feedback. If the user perceives that the spatial arrangement of the emblem in relation to the trunk lid also changes, the user can draw the conclusion that the touch will be detected. This is additionally amplified by the illumination of the emblem.

According to a further example, the detection device has at least one sensor configured to determine a displacement of the emblem in relation to the trunk lid. For this purpose, it can be provided that the sensor is configured as a gyroscope sensor. These types of sensors are distinguished by particularly accurate detection and are also especially long-lived.

According to a further example, the method comprises the following further step: Establishing whether a detected touch of the detection device originates from a user, based on parameters stored in a lookup table. For example, for this purpose by training the detection device in the case of touches which are not unambiguously detected, the probability can be increased that touches not originating from a user are incorrectly detected as a user touch. For example, it can occur that in a carwash a touch of a brush of the washing system is detected by the detection device. However, it would be disadvantageous if the trunk lid were to at least partially open on the basis of the detected touch. In order to counteract this, various parameters can be stored in the lookup table, on the basis of which the detection device can compare the detected measured variables with target values. For example, these can be repeating frequencies which are often generated by washing systems and act on the motor vehicle when it is in the washing system. Alternatively or additionally, an indicator can be stored in the lookup table which identifies the duration of the touch of the detection device that characterizes a disproportionately high probability that the detected touch originates from a user of the motor vehicle.

According to a further example, the method comprises the following further step: Adjusting an illumination of at least one of the following components of the motor vehicle depending on the detected touch: emblem, tail light, brake light, turn signal, reversing light. If, for example, the emblem of the motor vehicle is illuminated, the user receives feedback essentially immediately upon touching the emblem, since the focus of the user is also on the emblem at this moment. If, alternatively or additionally, the tail light, brake light, turn signal, and/or reversing light are also illuminated, the probability that the user perceives visual feedback via a detected touch of the user can be increased. In this context, the light can be configured such that the light has a predetermined number of pixels. By the pixels, it is possible to communicate predetermined patterns or even information in the form of characters or letters to the user. These can typically be safety symbols or warnings which signal to the user, for example, that the trunk lid will open soon and possibly a minimum distance of the user to the motor vehicle is to be maintained. Furthermore, it can be provided that at least one illumination varies over time. For example, it can be provided that a type of wiping movement of the tail light takes place, which extends starting from the emblem to the outer areas of the trunk lid. Specific pixels of the illumination devices are thus activated or deactivated in succession to display a certain animation to the user.

According to a further example, the method comprises the following further step: Outputting a predetermined acoustic signal depending on the detected touch. In this way, the user is not only given visual feedback that their touch has been detected. The user can also be notified about this acoustically. This is particularly useful in brightly lit situations where illumination of the emblem or another component of the motor vehicle is not entirely clearly recognizable to the user. Feedback which the user can perceive better can also be performed for visually impaired users.

According to a further example, it can be provided that a predetermined sequence of feedback to the user by the motor vehicle is provided. For example, it can be provided that the emblem illuminates when a touch of the user has been detected. If the trunk lid is then opened, the user can thus be informed by additional illumination, for example, of the tail lights, and/or by emission of one or more acoustic signals, that the trunk lid is opened. This therefore enhances the safety of the user, since they can adjust their position in relation to the motor vehicle on the basis of the feedback and, for example, the risk can be reduced that the user will be touched or even injured by the trunk lid during the opening procedure thereof.

According to a further example, upon the detection of the touch of the user, a fingerprint of the user is identified. This implementation allows a selection to take place on the basis of the identified fingerprint of whether the trunk lid is opened. For example, predetermined fingerprints can be stored in a lookup table, which, when one of these fingerprints is identified, are intended to cause opening of the trunk lid. If a fingerprint is identified which is not stored in the lookup table, it can be provided that the trunk lid is not opened. Alternatively or additionally, it can also be provided that a visual or acoustic signal is output which notifies the surroundings that an unauthorized user has touched the detection device. For example, an alarm system of the motor vehicle can thus be activated, by which an unauthorized access to the motor vehicle is signaled particularly effectively.

According to a further example, the method comprises the following further step: Controlling a component of the motor vehicle depending on the position of the user. This can be done in particular depending on the position of the trunk lid in relation to the user. In this way, the risk can be reduced that the user will be touched or even injured by adjusting the position of the trunk lid. If the user of the motor vehicle is located in the opening area of the trunk lid, for example, it can be provided that the trunk lid is only opened up to a predetermined range or a predetermined position, at which touching the user is improbable. In this context, a further step can also be useful, in which it is determined where the user is arranged in relation to the motor vehicle. On the basis of this, an acoustic signal can be output or a component of the motor vehicle can be illuminated. It can also be provided that the acoustic signal is output depending on the position. For example, the volume can be adjusted.

For example, the trunk lid can therefore be opened by operating the rear hatch via the illuminated emblem. The user approaches the rear of the motor vehicle and opens the rear hatch by pressing on the emblem of the motor vehicle. The motor vehicle detects or identifies the operation and interacts with the user by illuminating the emblem and playing an animation in the light strip and in the lights in the side wall frame. Potentially, a sound can additionally be played or a spoiler light can be actively switched on. Like a kind of theater curtain which "opens", the animation is played starting from the emblem, with the opening rear hatch as the final action. A saving of components can be achieved and a more uniform user experience with a feature can be achieved by the mentioned aspects and examples, which also saves production costs, among other things.

For application cases or application situations which can arise in the method and which are not explicitly described here, provision can be made for an error message and/or a request for input of a user acknowledgement to be output according to the method and/or for a default setting and/or a predetermined initial state to be set.

The invention according to the examples also includes the control device for the motor vehicle. The control device can comprise a data processing device or a processor unit (processor circuit) which is configured to carry out the method according to the examples of the invention. The processor unit can have at least one microprocessor and/or at least one microcontroller and/or at least one FPGA (Field Programmable Gate Array) and/or at least one DSP (Digital Signal Processor) for this purpose. In particular, a CPU (Central Processing Unit), a GPU (Graphical Processing Unit), or an NPU (Neural Processing Unit) can each be used as a microprocessor. Furthermore, the processor device can have program code which is configured to perform the method according to the examples of the invention when executed by the processor unit. The program code can be stored in a data memory of the processor unit. The processor unit can be based, for example, on at least one circuit board and/or on at least one SoC (System on Chip).

The invention according to the examples also includes refinements of the method according to the examples of the invention which have features, as have already been described in conjunction with the refinements of the motor vehicle according to the examples of the invention. For this reason, the corresponding refinements of the method according to the examples of the invention are not described here again.

The motor vehicle according to the examples of the invention may be configured as a motor vehicle, in particular as a passenger car or truck, or as a passenger bus or motorcycle.

As a further solution, the invention according to the examples also comprises a computer-readable storage medium comprising program code which, when executed by a computer or a computer network, causes the computer network to carry out the method according to the examples of the invention. The storage medium can be provided at least partially as a non-volatile data memory (e.g. as a flash memory and/or as an SSD – solid state drive) and/or at least partially as a volatile data memory (e.g. as a RAM – random access memory). The storage medium can be arranged in the computer or computer network. The storage medium can, however, also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (e.g. C) and/or as a program script (e.g. Python). The computer-readable storage medium can alternatively be implemented by a non-transitory signal having computer-readable data, for example a time-varying voltage signal and/or a radio signal.

The invention according to the examples, also comprises the combinations of the features of the examples described. The invention according to the examples thus also comprises implementations which each have a combination of the features of several of the examples described, unless the examples have been described as being mutually exclusive.

### BRIEF DESCRIPTION OF THE DRAWINGS

Examples of the invention are described below. In the figures:

FIG. 1 shows a flow chart of a method for opening a trunk lid of a motor vehicle;

FIG. 2 shows a detail of a motor vehicle in the side view; and

FIG. 3 shows a motor vehicle in the rear view.

### DESCRIPTION

The examples explained below are examples of the invention. In the examples, the described components of the examples are each individual features of the invention according to the example that should be considered independently of one another and that each also develop the invention according to the examples independently of one another. Therefore, the disclosure is intended to also comprise combinations of the features of the examples other than those depicted. Furthermore, the examples described can also be supplemented by further features of the invention according to the examples which have already been described.

In the figures, identical reference signs denote functionally identical elements in each case.

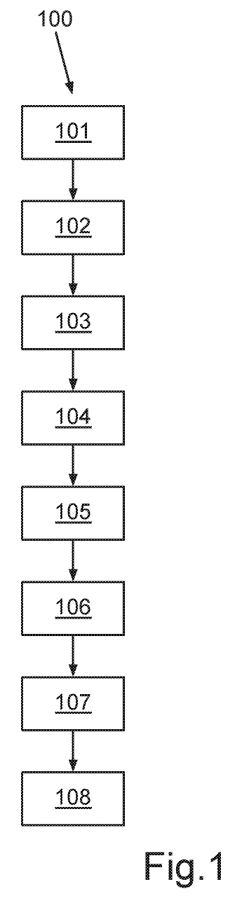

FIG. 1 shows a flow chart of a method 100 for opening a trunk lid 2 of a motor vehicle 1. In a first method step 101, a touch of a user 5 of the motor vehicle 1 is detected. This is carried out with the aid of a detection device 3, which is arranged on or in an emblem 4 of the trunk lid 2 of the motor vehicle 1. In this context, a touch can represent a push, stroke, or any other bringing into contact of a body part 6 of the user 5. It can also be provided that the detection device 3 is configured to be able to capture and detect a fingerprint of the user 5. In this respect, the method 100 has a further step 102, in which it is established whether a touch detected by the detection device 3 originates from the user 5. This can be carried out in this context on the basis of parameters stored in a lookup table. For example, one or more fingerprints of the user 5 can be stored in the lookup table, wherein the detection device 3 compares the detected fingerprint with the stored fingerprint.

In a further step 103, the trunk lid 2 is unlocked. It is taken into consideration here, among other things, whether and what has been detected by the detection device 3. In an example, the trunk lid 2 is only unlocked if a touch of the user 5, who is in particular authorized for the motor vehicle 1, has been detected. In parallel to or following step 103, furthermore at least partial illumination 104 of the emblem 4 takes place depending on the detected touch. Furthermore, an adaptation 105 of an illumination, for example, of the emblem 4, a tail light 7, a brake light 8, a turn signal 9, and/or a reversing light 10 of the motor vehicle 1 can take place depending on the detected touch. In a further step 107, a predetermined acoustic signal can be output depending on the detected touch. In this context, for example, the user 5 can be informed by a beep or a horn noise that a touch of the user 5 has been detected.

In a further step 107, the trunk lid 2 is at least partially opened in an automated manner. It can be provided that in a further step 108, at least one component of the motor vehicle 1 is controlled depending on the position of the user 5. In an example, the control 108 takes place depending on the position of the trunk lid 2. If, for example, a sensor of the motor vehicle 1 determines that a body part 6 of the user 5, such as their arm, is located in the opening area of the trunk lid 2, it can be provided that the opening of the trunk lid 2 is only carried out partially, so that touching the body part 6 is essentially avoided. In this way, a safety mechanism can be applied to reduce the risk of injury to the user 5 when opening the trunk lid 2. It is provided here that the trunk lid 2 is opened in an automated manner. This can be implemented, for example, in that after unlocking 103 of the trunk lid 2, a pre-tensioned spring automatically brings the trunk lid 2 into a starting position due to the tensioning force, in which the trunk lid 2 is open, on the one hand, and the pre-tension of the spring is at least partially reduced in comparison to the position in which the trunk lid 2 is essentially locked or closed, on the other hand.

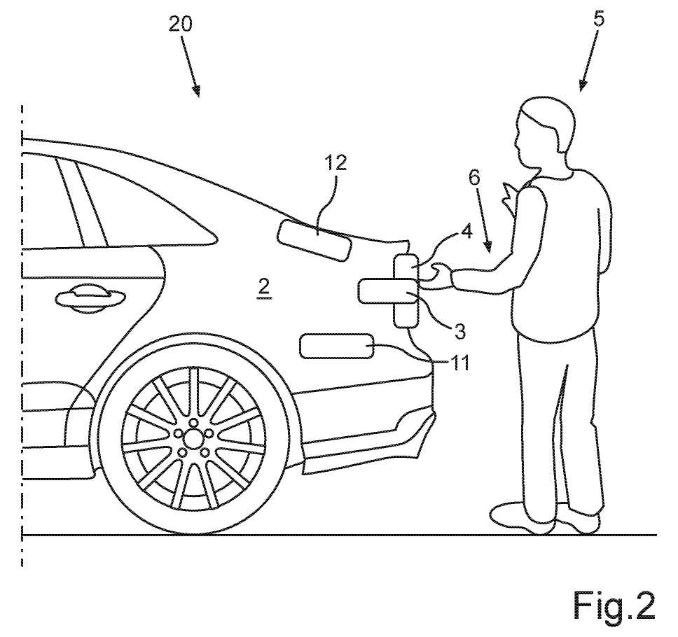

FIG. 2 shows a detail of a motor vehicle 1 in the side view. Essentially the rear area of the motor vehicle 1 is depicted here, wherein a user 5 of the motor vehicle 1 is arranged behind the motor vehicle 1. The trunk lid 2 is closed or locked in this illustration. As can be seen, the user 5 guides a body part 6, namely the hand of the user 5, into the area of the emblem 4 of the motor vehicle 1. As shown, this is usually located in the area of the trunk lid 2. The emblem 4 identifies a producer of the motor vehicle 1. In this example, the emblem 4, in an operating position in which the trunk lid 2 is locked, faces toward the user 5, i.e. the user 5 can touch the emblem 4 directly and immediately. Accordingly, the trunk lid 2 is also essentially completely visible to the user 5, since the user 5 is located in the surroundings of the motor vehicle 1, in which the user 5 can touch the emblem 4 with their hand 6. In order to detect a touch of the user 5, a detection device 3 is arranged on and/or in the emblem 4. This device can extend over only a part of the emblem 4 or can be arranged essentially in the emblem 4 in such a manner that a touch of the emblem 4 is detectable by the detection device 3. A touch of the emblem 4 can ensure here that the emblem 4 can be changed in relation to the trunk lid 2 or the motor vehicle 1. For example, it can be provided that by pressing the emblem 4, the emblem 4 can be tilted or rotated in relation to the horizontal. Alternatively or additionally, it can also be provided that the emblem 4 can be depressed. In this way, exerting pressure on the emblem 4 and therefore the detection device 3 can ensure that a touch of the user 5 can be detected.

Furthermore, the motor vehicle 1 has an unlocking device 11, by which the trunk lid 2 can be unlocked. Furthermore, the motor vehicle 1 has an opening device 12. This can be implemented, for example, as tension springs, which are configured, upon unlocking of the trunk lid 2, to transfer the essentially closed trunk lid 2 into an essentially open position. For this purpose, the opening device 12 can alternatively or additionally also have at least one motor, which is configured to transfer the position of the trunk lid 2 from an essentially closed operating position into an essentially open operating position.

A system 20 for carrying out the method 100 explained in FIG. 1 can include, for example, the detection device 3, the emblem 4, the unlocking device 11, and the opening device 12. It can be provided that the system 20 communicates with or controls other components of the motor vehicle 1.

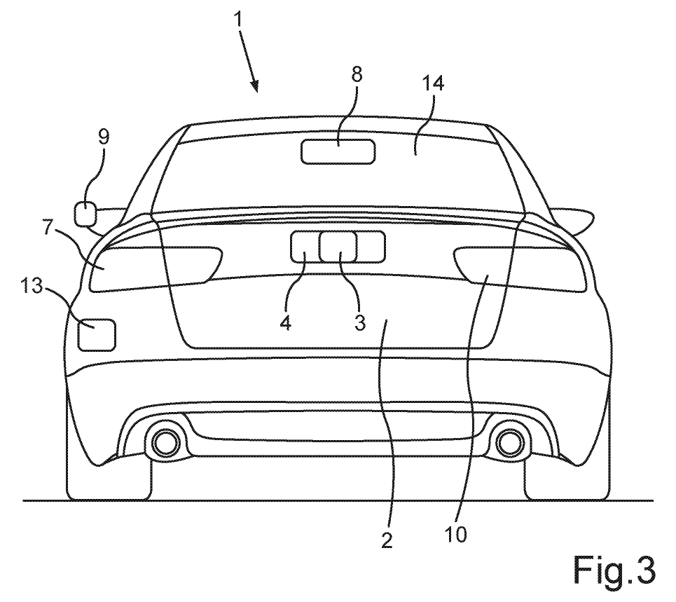

FIG. 3 shows a motor vehicle 1 in the rear view. In this case, the motor vehicle 1 has the emblem 4 having the detection device 3 at least partially integrated therein in the middle on or in the trunk lid 2. In addition, a lighting device may be integrated on or in the emblem 4, which is not shown in this illustration.

The system 20 arranged on or in the motor vehicle 1 is configured here to control lighting devices such as a tail light 7, a brake light or a spoiler light 8, a turn signal 9, or a reversing light 10 of the motor vehicle 1. Furthermore, the system 20, in particular its detection device 3, can be configured to control an acoustic output device 13. This can be used to notify the user 5 of hazards or also information not only visually, but also acoustically. In addition, it can also be provided that the spoiler light 8 is configured to communicate information, warnings, notifications, etc. to the user by projection on the rear window 14 of the motor vehicle 1. For example, the acoustic output device 13 and the spoiler light 8 can be enabled to inform the user that a touch of the user 5 has been detected and now the trunk lid 2 of the motor vehicle 1 is opened.

In order to enable interaction with the user 5 even in the open state of the trunk lid 2, it can be provided that the tail light 7, as illustrated, is formed in two parts. A first part of the tail light 7 is essentially arranged in a side wall frame of the motor vehicle 1. If the trunk lid 2 is at least partially opened, it is possible that the user 5 of the motor vehicle 1 can no longer perceive the brake light 8 or also the reversing light 10 or can only do so to a limited extent. However, since the tail light 7 is arranged unchanged on the motor vehicle 1, independently of a position or setting of the trunk lid 2, feedback can still or continuously be output to the user 5 and can be recognized by the user 5.

In an example, a pre-determined feedback pattern can be output during an opening procedure of the trunk lid 2. For example, upon touching of the emblem 4, first the emblem 4 can illuminate, then the turn signal 9 and the tail light 7 illuminate. Furthermore, an acoustic signal is output via the acoustic output device 13, which notifies the user 5 about the upcoming opening procedure of the trunk lid 2. In turn, this pattern can be played back in reverse sequence during a closing procedure.

Overall, the examples show how a method for opening a trunk lid of a motor vehicle, a system, a computer program, a computer-readable storage medium, and a motor vehicle can be provided.

A description has been provided with particular reference to examples, but it will be understood that variations and modifications can be effected within the spirit and scope of the claims, which may include the phrase "at least one of A, B and C" as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS

1 motor vehicle

2 trunk lid

3 detection device

4 emblem

5 user

6 body part

7 tail light

8 brake light / spoiler light

9 turn signals

10 reversing light

11 unlocking device

12 opening device

13 acoustic output device

14 rear window

20 system

1. A method of opening a trunk lid of a motor vehicle, comprising:
detecting a touch of a user by a detection device arranged on or in an emblem of the trunk lid;
by at least one processor configured to execute a control process including,
unlocking the trunk lid depending on the detected touch;
at least partially illuminating the emblem depending on the detected touch; and
at least partially opening the trunk lid in an automated manner.

2. The method as claimed in claim 1, wherein the emblem identifies a producer of the motor vehicle.

3. The method as claimed in claim 1, wherein the emblem, in an operating position in which the trunk lid is locked and a touch of the user is detectable, faces toward the user.

4. The method as claimed in claim 1, wherein the emblem is in a position such that the emblem is substantially fully visible to the user in an operating position in which the trunk lid is locked, when the user is in a surroundings of the motor vehicle in which the emblem is touchable with at least one body part of the user.

5. The method as claimed in claim 4, wherein the position of the emblem in relation to the motor vehicle is changeable by a touch of the user.

6. The method as claimed in claim 1, wherein the control process further comprises:
the at least partially illuminating of the emblem and adapting depending on the detected touch an illumination of at least one component among components of the motor vehicle including a tail light, a brake light, a turn signal, or a reversing light.

7. A system for a motor vehicle, comprising
a detection device arranged on or in an emblem of a trunk lid of the motor vehicle and configured to detect a touch of the emblem by a user;
at least one processor configured to execute a control process including,
unlocking the trunk lid depending on the detected touch;
at least partially illuminating the emblem depending on the detected touch; and
at least partially opening the trunk lid in an automated manner.

8. The system as claimed in claim 7, wherein the control process further comprises:
the at least partially illuminating of the emblem and adapting depending on the detected touch an illumination of at least one component among components of the motor vehicle including a tail light, a brake light, a turn signal, or a reversing light.

9. A non-transitory computer-readable storage medium comprising commands which, when executed by a computer, cause the computer to carry out the method as claimed in claim 1.

10. A motor vehicle, comprising:
a detection device arranged on or in an emblem of a trunk lid of the motor vehicle and configured to detect a touch of the emblem by a user;
at least one processor configured to execute a control process including,
unlocking the trunk lid depending on the detected touch;
at least partially illuminating the emblem depending on the detected touch; and
at least partially opening the trunk lid in an automated manner.

11. The motor vehicle as claimed in claim 10, wherein the control process further comprises:
the at least partially illuminating of the emblem and adapting depending on the detected touch an illumination of at least one component among components of the motor vehicle including a tail light, a brake light, a turn signal, or a reversing light.
